(19) United States
(12) Patent Application Publication
(10) Pub. No.: US 2025/0231900 A1
(43) Pub. Date: Jul. 17, 2025

(54) USB ROUTING INTEGRATED CIRCUIT WITH MULTIPLE USB UPSTREAM PORTS AND OPERATION METHOD THEREOF

(71) Applicant: VIA LABS, INC., New Taipei City (TW)

(72) Inventors: Terrance Shiyang Shih, New Taipei City (TW); Nai-Chuan Hung, New Taipei City (TW); Chin-Sung Hsu, New Taipei City (TW)

(73) Assignee: VIA LABS, INC., New Taipei City (TW)

(21) Appl. No.: 19/008,648

(22) Filed: Jan. 3, 2025

Related U.S. Application Data
(60) Provisional application No. 63/621,595, filed on Jan. 17, 2024.

(30) Foreign Application Priority Data
Oct. 23, 2024 (TW) 113140381

(51) Int. Cl. G06F 13/40; G06F 13/38

(52) U.S. Cl. CPC G06F 13/4022; G06F 13/385; G06F 2213/0042

(57) ABSTRACT

Disclosed are a USB routing integrated circuit (IC) with multiple USB upstream ports and operation method thereof. The USB routing IC includes a first USB upstream port, a second USB upstream port, a USB downstream port, a video output port, a first multiplexer, a second multiplexer, a first switching circuit and a second switching circuit. The first multiplexer is coupled to the first USB upstream port. The second multiplexer is coupled to the second USB upstream port. The first switching circuit is coupled between the first multiplexer and the USB downstream port. The first switching circuit is coupled between the second multiplexer and the USB downstream port. The second switching circuit is coupled between the first multiplexer and the video output port. The second switching circuit is coupled between the second multiplexer and the video output port.

### CROSS-REFERENCE TO RELATED APPLICATION

This application claims the priority benefit of U.S. provisional application Ser. No. 63/621,595, filed on Jan. 17, 2024, and Taiwan application serial no. 113140381, filed on Oct. 23, 2024. The entirety of each of the above-mentioned patent applications is hereby incorporated by reference herein and made a part of this specification.

### BACKGROUND

### Technical Field

The present disclosure relates to an integrated circuit, and more particularly to a USB routing integrated circuit with multiple Universal Serial Bus (USB) upstream ports and an operation method thereof.

### Description of Related Art

The Universal Serial Bus (USB) is a data transfer interface for connecting hosts and devices. Contemporary computers, mobile phones, and other products are equipped with USB interfaces. A USB architecture includes only one “USB host,” while other electronic devices are classified as “USB devices.” The USB devices may include Human Interface Devices (HIDs) or other peripheral equipment. The HID may include a keyboard, a mouse, or other devices. Generally, a USB integrated circuit possesses only one USB upstream port for connection to a USB upstream connector (USB host). The facilitation of multiple USB hosts sharing the same resources constitutes one of the numerous technical challenges in the USB domain.

### SUMMARY

The present disclosure provides a USB routing integrated circuit with multiple Universal Serial Bus (USB) upstream ports and an operation method thereof, which flexibly provides transmission paths from different upstream ports (first USB upstream port, second USB upstream port) to different downstream ports (USB downstream port, video output port).

In an embodiment of the present disclosure, the USB routing integrated circuit includes a first USB upstream port, a second USB upstream port, a USB downstream port, a video output port, a first multiplexer, a second multiplexer, a first switching circuit, and a second switching circuit. The first multiplexer is coupled to the first USB upstream port. The second multiplexer is coupled to the second USB upstream port. The first switching circuit is coupled between the first multiplexer and the USB downstream port. The first switching circuit is also coupled between the second multiplexer and the USB downstream port. The first switching circuit selectively electrically connects one of the first multiplexer and the second multiplexer to the USB downstream port in different operation modes. The second switching circuit is coupled between the first multiplexer and the video output port. The second switching circuit is also coupled between the second multiplexer and the video output port. The second switching circuit selectively electrically connects one of the first multiplexer and the second multiplexer to the video output port in different operation modes. The first multiplexer selectively electrically connects the first USB upstream port to one of the first switching circuit and the second switching circuit in different operation modes. The second multiplexer selectively electrically connects the second USB upstream port to one of the first switching circuit and the second switching circuit in different operation modes.

In an embodiment of the present disclosure, the operation method includes: selectively electrically connecting, by a first switching circuit, one of the first multiplexer and the second multiplexer to a USB downstream port in different operation modes; selectively electrically connecting, by a second switching circuit, one of the first multiplexer and the second multiplexer to a video output port in different operation modes; selectively electrically connecting, by the first multiplexer, a first USB upstream port to one of the first switching circuit and the second switching circuit in different operation modes; and selectively electrically connecting, by the second multiplexer, a second USB upstream port to one of the first switching circuit and the second switching circuit in different operation modes.

Based on the foregoing, the USB routing integrated circuit described in the various embodiments of the present disclosure includes multiple upstream ports (a first USB upstream port and a second USB upstream port) and multiple downstream ports (a USB downstream port and a video output port). The first multiplexer, second multiplexer, first switching circuit, and second switching circuit are capable of flexibly providing different transmission paths from various upstream ports to various downstream ports, contingent upon the actual application/operation modes of the USB routing integrated circuit.

In order to render the aforementioned features and advantages of the present disclosure more apparent and comprehensible, exemplary embodiments will be described in detail hereinafter with reference to the accompanying drawings.

### BRIEF DESCRIPTION OF THE DRAWINGS

FIG. 1 is a circuit block diagram illustrating a USB routing integrated circuit with multiple USB upstream ports according to an embodiment of the present disclosure.

FIG. 2 is a flowchart illustrating an operation method of a USB routing integrated circuit with multiple USB upstream ports according to an embodiment of the present disclosure.

FIG. 3 is a circuit block diagram illustrating a USB routing integrated circuit with multiple USB upstream ports according to another embodiment of the present disclosure.

FIG. 4 illustrates a circuit block diagram of a monitor device according to an embodiment of the present disclosure.

FIG. 5 to FIG. 7 illustrate are schematic diagrams depicting various operation modes of the monitor device and the USB routing integrated circuit according to an embodiment of the present disclosure.

FIG. 8 illustrates a circuit block diagram of a dock of a mobile device according to another embodiment of the present disclosure.

FIG. 9 and FIG. 10 illustrate different operation modes of the dock and the USB routing integrated circuit according to another embodiment of the present disclosure.

### DESCRIPTION OF THE EMBODIMENTS

In the entirety of this specification (including the claims), the term “coupled (or connected)” may refer to any direct or indirect means of connection. For example, if a first device is described as being coupled (or connected) to a second device, it should be construed that the first device may be directly connected to the second device, or the first device may be indirectly connected to the second device through other devices or some means of connection. The terms “first,” “second,” etc., used throughout this specification (including the claims) are employed to designate elements or to distinguish different embodiments or scopes, and are not intended to limit the maximum or minimum number of elements, nor to restrict their sequence. Furthermore, where possible, elements/components/steps denoted by the same reference numerals in the drawings and embodiments represent identical or similar parts. Elements/components/steps in different embodiments that are denoted by the same reference numerals or described using the same terminology may be cross-referenced for relevant explanations.

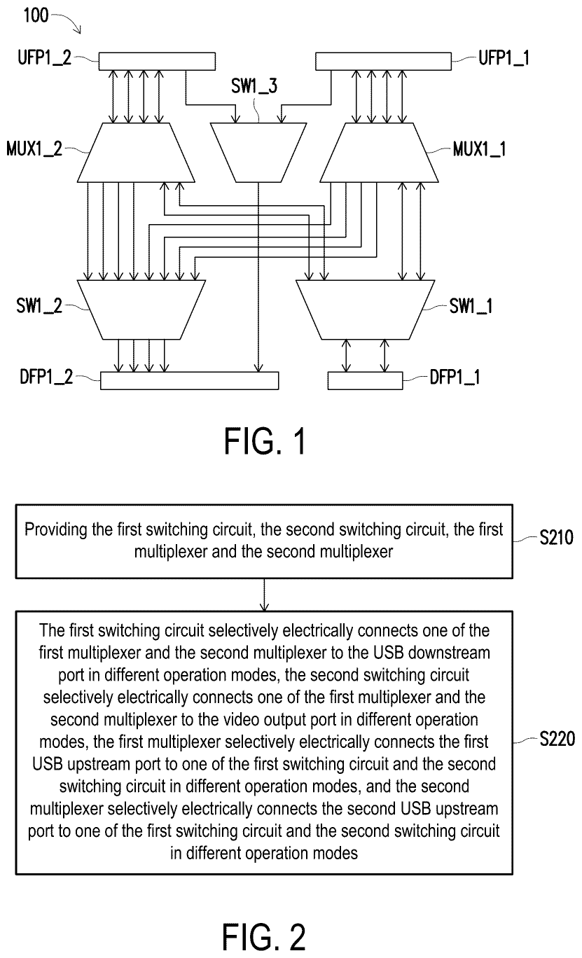

FIG. 1 is a circuit block diagram illustrating a USB routing integrated circuit 100 with multiple Universal Serial Bus (USB) upstream ports according to an embodiment of the present disclosure. The USB routing integrated circuit 100 shown in FIG. 1 includes multiple upstream ports (e.g., USB upstream port UFP1_1 and USB upstream port UFP1_2) and multiple downstream ports (e.g., USB downstream port DFP1_1 and video output port DFP1_2). According to the actual design, in some embodiments, the upstream ports may be Upstream Facing Ports (UFPs) as defined by the USB standard or upstream ports defined by other specifications, while the downstream ports may be Downstream Facing Ports (DFPs) as defined by the USB standard or downstream ports defined by other specifications. The USB routing integrated circuit 100 shown in FIG. 1 further includes a multiplexer MUX1_1 and a multiplexer MUX1_2, as well as a switching circuit SW1_1, a switching circuit SW1_2, and a switching circuit SW1_3.

FIG. 2 illustrates a flowchart of an operation method of a USB routing integrated circuit with multiple USB upstream ports according to an embodiment of the present disclosure. Referring to FIG. 1 and FIG. 2, step S210 provides the switching circuit SW1_1, the switching circuit SW1_2, the multiplexer MUX1_1 and the multiplexer MUX1_2. The multiplexer MUX1_1 is coupled to the high-speed data pin pairs of the USB upstream port UFP1_1 (e.g., the “TX1+, TX1−”, “RX1+, RX1−”, “TX2+, TX2−”, and “RX2+, RX2−” differential pin pairs as defined by the USB standard). The multiplexer MUX1_1 is coupled between the USB upstream port UFP1_1 and the switching circuit SW1_1. The multiplexer MUX1_1 is further coupled between the USB upstream port UFP1_1 and the switching circuit SW1_2. The multiplexer MUX1_2 is coupled to the high-speed data pin pairs of the USB upstream port UFP1_2 (e.g., the “TX1+, TX1−”, “RX1+, RX1−”, “TX2+, TX2−”, and “RX2+, RX2−” differential pin pairs as defined by the USB standard). The multiplexer MUX1_2 is coupled between the USB upstream port UFP1_2 and the switching circuit SW1_1. The multiplexer MUX1_2 is further coupled between the USB upstream port UFP1_2 and the switching circuit SW1_2.

The switching circuit SW1_1 is coupled to the high-speed data pin pairs of the USB downstream port DFP1_1 (e.g., the “TX1+, TX1−”, “RX1+, RX1−”, “TX2+, TX2−”, and “RX2+, RX2−” differential pin pairs as defined by the USB standard). The switching circuit SW1_1 is coupled between the multiplexer MUX1_1 and the USB downstream port DFP1_1. The switching circuit SW1_1 is coupled between the multiplexer MUX1_2 and the USB downstream port DFP1_1. The switching circuit SW1_2 is coupled to the high-speed data pin pairs of the video output port DFP1_2 (e.g., the “ML_Lane 0”, “ML_Lane 1”, “ML_Lane 2”, and “ML_Lane 3” differential pin pairs as defined by the DisplayPort (DP) standard). The switching circuit SW1_2 is coupled between the multiplexer MUX1_1 and the video output port DFP1_2. The switching circuit SW1_2 is coupled between the multiplexer MUX1_2 and the video output port DFP1_2. The switching circuit SW1_3 is coupled to the Sideband Use (SBU) pin of the USB upstream port UFP1_1. The switching circuit SW1_3 is coupled to the SBU pin of the USB upstream port UFP1_2. The switching circuit SW1_3 is coupled to the auxiliary channel (AUX_CH) pin of the video output port DFP1_2.

Based on the actual application/operation modes of the USB routing integrated circuit 100 (i.e., based on different operation modes), the multiplexer MUX1_1, the multiplexer MUX1_2, the switching circuit SW1_1, and the switching circuit SW1_2 may flexibly provide transmission paths from different upstream ports (e.g., USB upstream port UFP1_1 and USB upstream port UFP1_2) to different downstream ports (e.g., USB downstream port DFP1_1 and video output port DFP1_2) in step S220. In various operation modes, the multiplexer MUX1_1 selectively electrically connects the USB upstream port UFP1_1 to one of the switching circuit SW1_1 and the switching circuit SW1_2; the multiplexer MUX1_2 selectively electrically connects the USB upstream port UFP1_2 to one of the switching circuit SW1_1 and the switching circuit SW1_2; the switching circuit SW1_1 selectively electrically connects one of the multiplexer MUX1_1 and the multiplexer MUX1_2 to the USB downstream port DFP1_1; and the switching circuit SW1_2 selectively electrically connects one of the multiplexer MUX1_1 and the multiplexer MUX1_2 to the video output port DFP1_2. The switching circuit SW1_3 may selectively electrically connect the SBU pin of one of the USB upstream port UFP1_1 and the USB upstream port UFP1_2 to the AUX_CH pin of the video output port DFP1_2 in different operation modes. Specific examples of different operation modes will be explained subsequently.

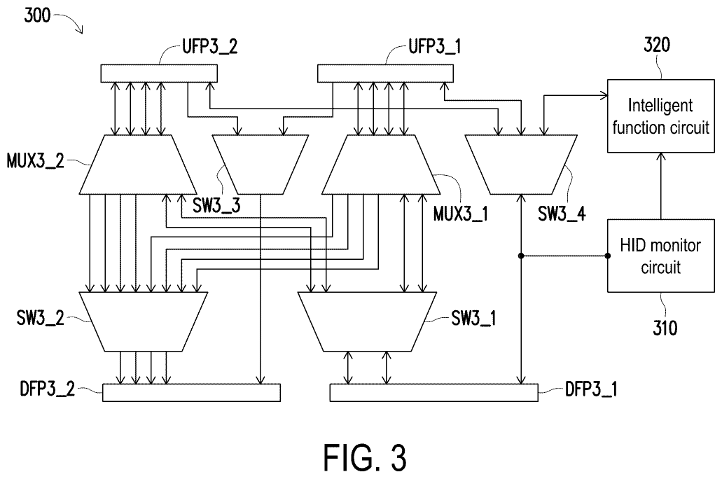

FIG. 3 illustrates a circuit block diagram of a USB routing integrated circuit 300 with multiple USB upstream ports according to another embodiment of the present disclosure. The USB routing integrated circuit 300 shown in FIG. 3 includes a multiplexer MUX3_1, a multiplexer MUX3_2, a switching circuit SW3_1, a switching circuit SW3_2, a switching circuit SW3_3, a switching circuit SW3_4, a Human Interface Device (HID) monitor circuit 310, an intelligent function circuit 320, multiple upstream ports (e.g., USB upstream port UFP3_1 and USB upstream port UFP3_2), and multiple downstream ports (e.g., USB downstream port DFP3_1 and video output port DFP3_2). The USB routing integrated circuit 300, the multiplexer MUX3_1, the multiplexer MUX3_2, the switching circuit SW3_1, the switching circuit SW3_2, the switching circuit SW3_3, the USB upstream port UFP3_1, the USB upstream port UFP3_2, the USB downstream port DFP3_1, and the video output port DFP3_2 shown in FIG. 3 may be understood by reference to the relevant descriptions of the USB routing integrated circuit 100, the multiplexer MUX1_1, the multiplexer MUX1_2, the switching circuit SW1_1, the switching circuit SW1_2, the switching circuit SW1_3, the USB upstream port UFP1_1, the USB upstream port UFP1_2, the USB downstream port DFP1_1, and the video output port DFP1_2 shown in FIG. 1, and may be extrapolated therefrom. Therefore, further elaboration is omitted.

The switching circuit SW3_4 is coupled to the USB2 data pin pair (for example, the “D+, D−” differential pin pair as defined by the USB standard) of the USB upstream port UFP3_1. The switching circuit SW3_4 is coupled to the USB2 data pin pair (for example, the “D+, D−” differential pin pair as defined by the USB standard) of the USB upstream port UFP3_2. The switching circuit SW3_4 is coupled to the USB2 data pin pair (for example, the “D+, D−” differential pin pair as defined by the USB standard) of the USB downstream port DFP3_1. The switching circuit SW3_4 may selectively electrically connect one of the USB2 data pin pair of the USB upstream port UFP3_1 and the USB2 data pin pair of the USB upstream port UFP3_2 to the USB2 data pin pair of the USB downstream port DFP3_1 in different operation modes. Specific examples of different operation modes will be described later.

The HID monitor circuit 310 is coupled to the intelligent function circuit 320. The HID monitor circuit 310 is coupled to the data transmission path between the switching circuit SW3_4 and the USB2 data pin pair of the USB downstream port DFP3_1, as shown in FIG. 3. The HID monitor circuit 310 may monitor HID data packets transmitted on the data transmission path to determine whether to notify the intelligent function circuit 320 to execute intelligent functions. The intelligent functions may be configured according to actual design requirements. For example (but not limited to), the intelligent functions may include one or more of the following. The intelligent function circuit 320 controls the switching circuit SW3_3 to electrically connect the SBU pin of the USB upstream port UFP3_1 to the AUX_CH pin of the video output port DFP3_2, or controls the switching circuit SW3_3 to electrically connect the SBU pin of the USB upstream port UFP3_2 to the AUX_CH pin of the video output port DFP3_2. The intelligent function circuit 320 controls the switching circuit SW3_4 to electrically connect the USB2 data pin pair of the USB upstream port UFP3_1 to the USB2 data pin pair of the USB downstream port DFP3_1, or controls the switching circuit SW3_4 to electrically connect the USB2 data pin pair of the USB upstream port UFP3_2 to the USB2 data pin pair of the USB downstream port DFP3_1, or controls the switching circuit SW3_4 to electrically connect the intelligent function circuit 320 to the USB2 data pin pair of the USB downstream port DFP3_1.

The HID monitor circuit 310 is capable of monitoring HID data packets and determining whether a predefined event (such as a specific gesture, specific key press, or specific key combination) has occurred. Upon the occurrence of a predefined event, the HID monitor circuit 310 may notify the intelligent function circuit 320 to execute intelligent functions. For instance, the intelligent function circuit 320 may trigger the display module of the system (not illustrated in FIG. 3) to display standby OSD (on-screen display) information (e.g., date and time). For example, the intelligent function circuit 320 may control the multiplexer MUX3_1 and the multiplexer MUX3_2 to select either the USB upstream port UFP3_1 or the USB upstream port UFP3_2. Furthermore, the HID monitor circuit 310 may notify the intelligent function circuit 320 to control the switching circuit SW3_4 to select the USB upstream port UFP3_1, the USB upstream port UFP3_2, or the intelligent function circuit 320. When the intelligent function circuit 320 is selected, the HID device (such as mouse, keyboard, etc.) connected to the USB downstream port DFP3_1 may perform human-computer interaction with the intelligent function circuit 320 through the USB downstream port DFP3_1 and the switching circuit SW3_4 to perform advanced intelligent functions (e.g., updating/setting system parameters).

In accordance with various designs, in some embodiments, the HID monitor circuit 310 and/or the intelligent function circuit 320 may be implemented as hardware circuits. In other embodiments, the implementation of the HID monitor circuit 310 and/or the intelligent function circuit 320 may take the form of a combination of multiple elements, including hardware, firmware, and software (i.e., programs).

From a hardware perspective, the HID monitor circuit 310 and/or the intelligent function circuit 320 may be implemented as logic circuits on an integrated circuit. For instance, the functions related to the HID monitor circuit 310 and/or the intelligent function circuit 320 may be implemented in one or more hardware controllers, microcontrollers, hardware processors, microprocessors, application-specific integrated circuits (ASICs), digital signal processors (DSPs), field-programmable gate arrays (FPGAs), central processing units (CPUs), and/or various logic blocks, modules, and circuits within other processing units. The functions related to the HID monitor circuit 310 and/or the intelligent function circuit 320 may be implemented as hardware circuits, such as various logic blocks, modules, and circuits within integrated circuits, utilizing hardware description languages (e.g., Verilog HDL or VHDL) or other suitable programming languages.

With respect to software and/or firmware implementations, the functions related to the HID monitor circuit 310 and/or the intelligent function circuit 320 may be realized as programming codes. For instance, the HID monitor circuit 310 and/or the intelligent function circuit 320 may be implemented using general programming languages (such as C, C++, or assembly language) or other suitable programming languages. The programming codes may be recorded/stored in a non-transitory machine-readable storage medium. In some embodiments, the non-transitory machine-readable storage medium may include, but is not limited to, semiconductor memories and/or storage devices. The semiconductor memories include memory cards, Read Only Memory (ROM), FLASH memory, programmable logic circuits, or other semiconductor memories. The storage devices include hard disk drives (HDD), Solid-state drives (SSD), or other storage devices. Electronic devices (such as CPUs, hardware controllers, microcontrollers, hardware processors, or microprocessors) may read and execute the programming codes from the non-transitory machine-readable storage medium, thereby implementing the functions related to the HID monitor circuit 310 and/or the intelligent function circuit 320.

The USB routing integrated circuit 100 depicted in FIG. 1 and the USB routing integrated circuit 300 depicted in FIG. 3 may be applied to various USB products. For instance, the USB routing integrated circuit 100 or 300 may be implemented in KVM (keyboard, video, mouse) switches, monitors (i.e., displays), mobile device docks, or other USB products. The following explanation will utilize the USB routing integrated circuit 300 illustrated in FIG. 3 as an exemplary embodiment. The USB routing integrated circuit 100 shown in FIG. 1 may be understood by reference to and extrapolation from the relevant explanations pertaining to the USB routing integrated circuit 300 depicted in FIG. 3.

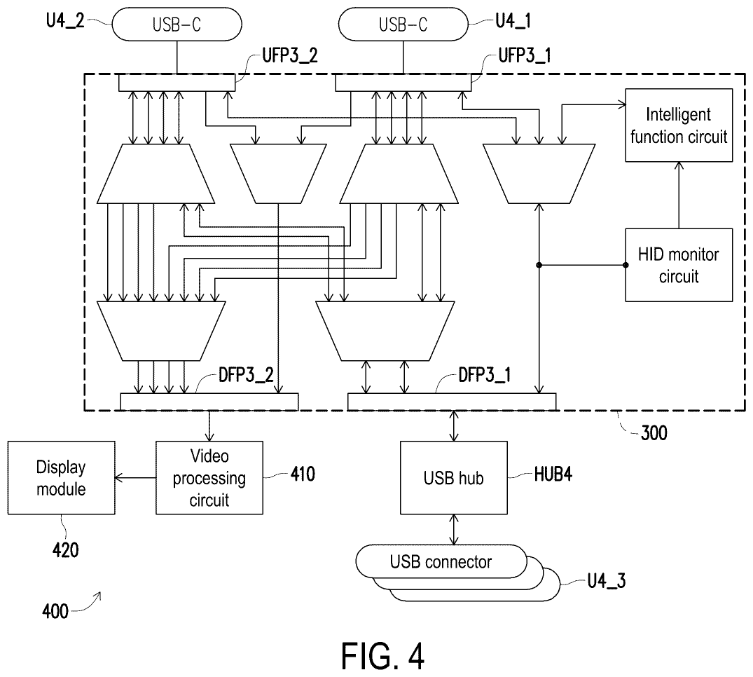

FIG. 4 illustrates a circuit block diagram of a monitor device 400 according to an embodiment of the present disclosure. In the embodiment shown in FIG. 4, the USB routing integrated circuit 300 is applied in the monitor device 400. The monitor device 400 shown in FIG. 4 includes a USB-C connector U4_1, a USB-C connector U4_2, a USB routing integrated circuit 300, a video processing circuit 410, a display module 420, a USB hub HUB4, and multiple USB connectors U4_3. The USB routing integrated circuit 300 shown in FIG. 4 may be referred to the relevant description of the USB routing integrated circuit 300 shown in FIG. 3, and therefore will not be elaborated upon herein.

The USB upstream port UFP3_1 of the USB routing integrated circuit 300 is electrically connected to the USB-C connector U4_1 of the monitor device 400. The USB upstream port UFP3_2 of the USB routing integrated circuit 300 is electrically connected to the USB-C connector U4_2 of the monitor device 400. Based on practical operation modes, the USB-C connector U4_1 and/or the USB-C connector U4_2 may be connected to any type of USB host. The USB downstream port DFP3_1 of the USB routing integrated circuit 300 is electrically connected to the USB hub HUB4 of the monitor device 400. The USB hub HUB4 is electrically connected to multiple USB connectors U4_3 of the monitor device 400. The video output port DFP3_2 of the USB routing integrated circuit 300 is electrically connected to the video processing circuit 410 of the monitor device 400. Based on practical application modes, the video processing circuit 410 may include a scaler and/or other video processing circuits. The video processing circuit 410 may generate video data for the display module 420 of the monitor device 400.

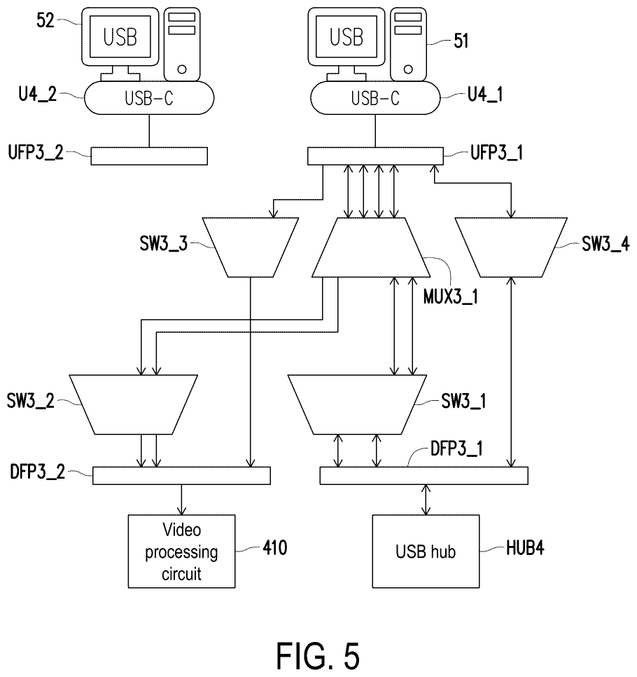

FIG. 5 to FIG. 7 illustrate are schematic diagrams depicting various operation modes of the monitor device 400 and the USB routing integrated circuit 300 according to an embodiment of the present disclosure. The USB-C connector U4_1, the USB-C connector U4_2, the USB hub HUB4, and the video processing circuit 410 shown in FIG. 5 may be referenced to the corresponding descriptions of the USB-C connector U4_1, the USB-C connector U4_2, the USB hub HUB4, and the video processing circuit 410 as depicted in FIG. 4. Similarly, the USB upstream port UFP3_1, the USB upstream port UFP3_2, the switching circuit SW3_4, the multiplexer MUX3_1, the switching circuit SW3_3, the switching circuit SW3_1, the switching circuit SW3_2, the USB downstream port DFP3_1, and the video output port DFP3_2 shown in FIG. 5 may be referenced to the corresponding descriptions of the USB upstream port UFP3_1, the USB upstream port UFP3_2, the switching circuit SW3_4, the multiplexer MUX3_1, the switching circuit SW3_3, the switching circuit SW3_1, the switching circuit SW3_2, the USB downstream port DFP3_1, and the video output port DFP3_2 as depicted in FIG. 3. Therefore, redundant explanations will not be provided herein.

In the operation mode illustrated in FIG. 5, the USB-C connector U4_1 is connected to the USB host 51, while the USB-C connector U4_2 is connected to the USB host 52. In the operation mode depicted in FIG. 5, the multiplexer MUX3_2 shown in FIG. 3 may be disabled. The switching circuit SW3_3 electrically connects the SBU pin of the USB upstream port UFP3_1 to the AUX_CH pin of the video output port DFP3_2. The switching circuit SW3_4 electrically connects the USB2 data pin pair of the USB upstream port UFP3_1 to the USB2 data pin pair of the USB downstream port DFP3_1. The multiplexer MUX3_1 and the switching circuit SW3_1 electrically connect two high-speed data pin pairs of the USB upstream port UFP3_1 to the USB downstream port DFP3_1. Additionally, the multiplexer MUX3_1 and the switching circuit SW3_2 electrically connect another two high-speed data pin pairs of the USB upstream port UFP3_1 to the video output port DFP3_2. Consequently, the USB host 51 may utilize the resources associated with the USB hub HUB4 and the video processing circuit 410.

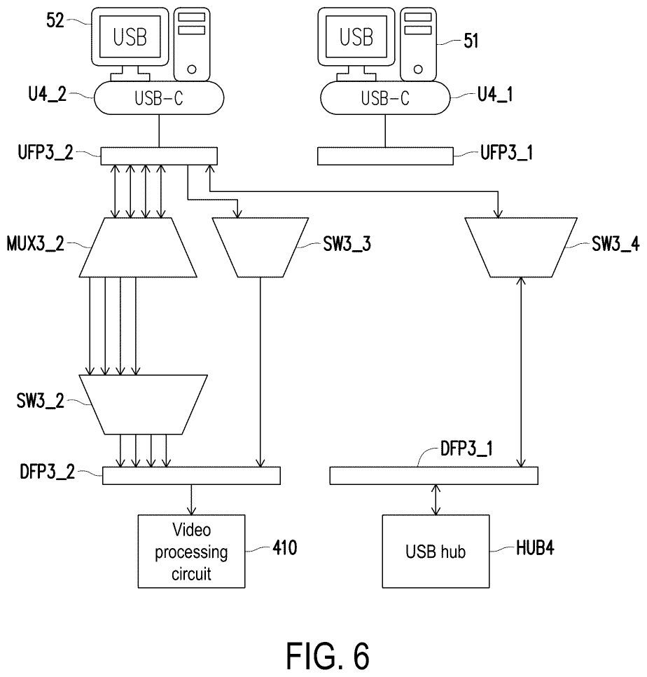

The USB-C connector U4_1, the USB-C connector U4_2, the USB hub HUB4, and the video processing circuit 410 shown in FIG. 6 may be referenced to the corresponding descriptions of the USB-C connector U4_1, the USB-C connector U4_2, the USB hub HUB4, and the video processing circuit 410 illustrated in FIG. 4. Similarly, the USB upstream port UFP3_1, the USB upstream port UFP3_2, the switching circuit SW3_4, the switching circuit SW3_3, the multiplexer MUX3_2, the switching circuit SW3_2, the USB downstream port DFP3_1, and the video output port DFP3_2 depicted in FIG. 6 may be referenced to the corresponding descriptions of the USB upstream port UFP3_1, the USB upstream port UFP3_2, the switching circuit SW3_4, the switching circuit SW3_3, the multiplexer MUX3_2, the switching circuit SW3_2, the USB downstream port DFP3_1, and the video output port DFP3_2 shown in FIG. 3. Therefore, further elaboration on these components will not be provided herein to avoid redundancy.

In the operation mode illustrated in FIG. 6, the USB-C connector U4_1 is connected to the USB host 51, while the USB-C connector U4_2 is connected to the USB host 52. In the operation mode depicted in FIG. 6, the multiplexer MUX3_1 and the switching circuit SW3_1 shown in FIG. 3 may be disabled. The switching circuit SW3_3 electrically connects the SBU pin of the USB upstream port UFP3_2 to the AUX_CH pin of the video output port DFP3_2. The switching circuit SW3_4 electrically connects the USB2 data pin pair of the USB upstream port UFP3_2 to the USB2 data pin pair of the USB downstream port DFP3_1. The multiplexer MUX3_2 and the switching circuit SW3_2 electrically connect the four high-speed data pin pairs of the USB upstream port UFP3_1 to the video output port DFP3_2. Consequently, the USB host 52 may utilize the resources associated with the USB hub HUB4 and the video processing circuit 410.

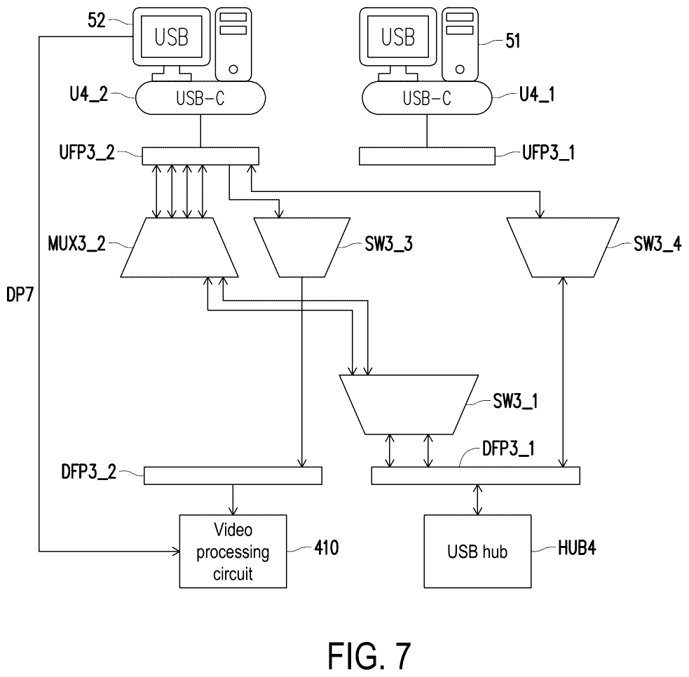

The USB-C connector U4_1, the USB-C connector U4_2, the USB hub HUB4, and the video processing circuit 410 shown in FIG. 7 may be referenced to the corresponding descriptions of the USB-C connector U4_1, the USB-C connector U4_2, the USB hub HUB4, and the video processing circuit 410 illustrated in FIG. 4. The USB upstream port UFP3_1, the USB upstream port UFP3_2, the switching circuit SW3_4, the switching circuit SW3_3, the multiplexer MUX3_2, the switching circuit SW3_1, the USB downstream port DFP3_1, and the video output port DFP3_2 depicted in FIG. 7 may be referenced to the corresponding descriptions of the USB upstream port UFP3_1, the USB upstream port UFP3_2, the switching circuit SW3_4, the switching circuit SW3_3, the multiplexer MUX3_2, the switching circuit SW3_1, the USB downstream port DFP3_1, and the video output port DFP3_2 shown in FIG. 3. Therefore, further elaboration on these components will not be provided herein to avoid redundancy.

In the operation mode illustrated in FIG. 7, the USB-C connector U4_1 is connected to the USB host 51, while the USB-C connector U4_2 is connected to the USB host 52. Additionally, the USB host 52 outputs video data to the video processing circuit 410 through the DP cable DP7. In the operation mode shown in FIG. 7, the multiplexer MUX3_1 and the switching circuit SW3_2, as depicted in FIG. 3, may be disabled. The switching circuit SW3_3 electrically connects the SBU pin of the USB upstream port UFP3_2 to the AUX_CH pin of the video output port DFP3_2. The switching circuit SW3_4 electrically connects the USB2 data pin pair of the USB upstream port UFP3_2 to the USB2 data pin pair of the USB downstream port DFP3_1. Furthermore, the multiplexer MUX3_2 and the switching circuit SW3_1 electrically connect the two high-speed data pin pairs of the USB upstream port UFP3_2 to the USB downstream port DFP3_1. Consequently, the USB host 52 may utilize the resources associated with the USB hub HUB4 and the video processing circuit 410.

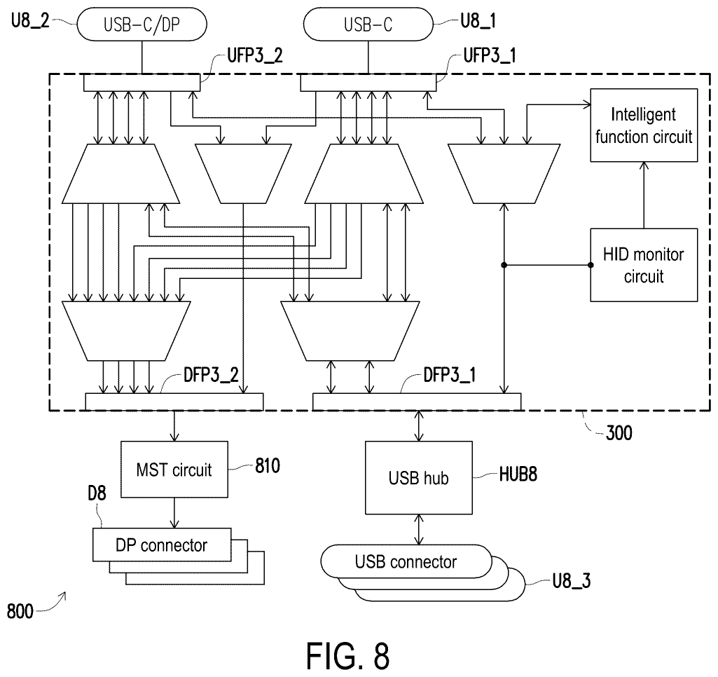

FIG. 8 illustrates a circuit block diagram of a dock 800 of a mobile device according to another embodiment of the present disclosure. In the embodiment shown in FIG. 8, the USB routing integrated circuit 300 is applied to the dock 800. The dock 800 shown in FIG. 8 includes a USB-C connector U8_1, a connector U8_2 (such as a USB-C connector or a DP connector), a USB routing integrated circuit 300, a Multi-Stream Transport (MST) circuit 810, a USB hub HUB8, multiple DP connectors D8, and multiple USB connectors U8_3. The USB routing integrated circuit 300 shown in FIG. 8 may be referenced to the relevant description of the USB routing integrated circuit 300 shown in FIG. 3, and therefore will not be repeated here.

The USB upstream port UFP3_1 of the USB routing integrated circuit 300 is electrically connected to the USB-C connector U8_1 of the dock 800. The USB upstream port UFP3_2 of the USB routing integrated circuit 300 is electrically connected to the connector U8_2 (e.g., a USB-C connector or a DP connector) of the dock 800. Based on practical operation modes, the USB-C connector U8_1 and/or the connector U8_2 may be connected to any type of mobile device (for example, but not limited to, a USB host, a laptop, or a mobile phone). The USB downstream port DFP3_1 of the USB routing integrated circuit 300 is electrically connected to the USB hub HUB8 of the dock 800. The USB hub HUB8 is electrically connected to multiple USB connectors U8_3 of the dock 800. The video output port DFP3_2 of the USB routing integrated circuit 300 is electrically connected to the MST circuit 810 of the dock 800. The MST circuit 810 is electrically connected to multiple DP connectors D8 of the dock 800. Displays or other external devices (not shown in FIG. 8) may be coupled to the DP connectors D8. The MST circuit 810 may generate video data for the DP connectors D8 of the dock 800.

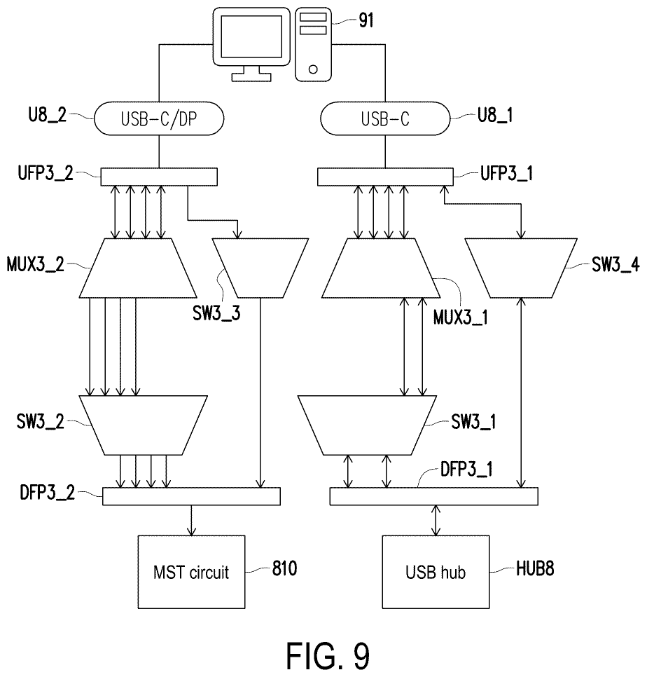

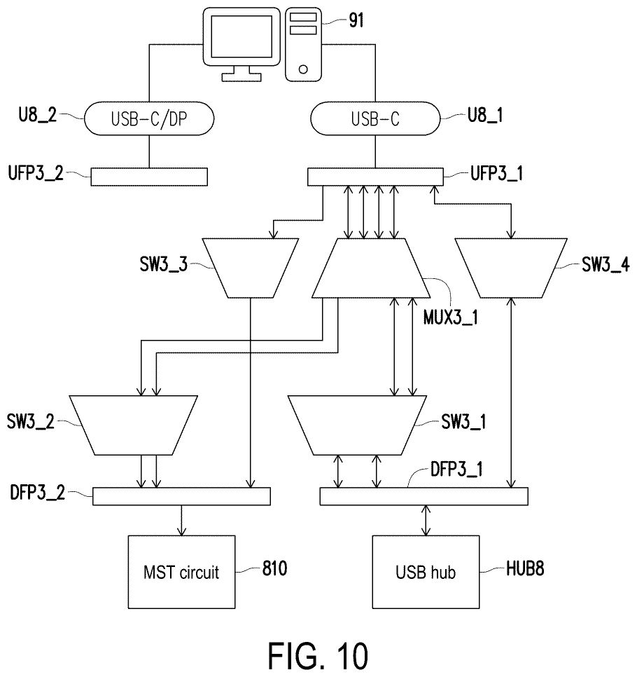

FIG. 9 and FIG. 10 illustrate different operation modes of the dock 800 and the USB routing integrated circuit 300 according to another embodiment of the present disclosure. The USB-C connector U8_1, the connector U8_2, the USB hub HUB8, and the video processing circuit 810 shown in FIG. 9 may be referenced to the corresponding descriptions of the USB-C connector U8_1, the connector U8_2, the USB hub HUB8, and the video processing circuit 810 as depicted in FIG. 8. The USB upstream port UFP3_1, the USB upstream port UFP3_2, the switching circuit SW3_4, the multiplexer MUX3_1, the switching circuit SW3_3, the multiplexer MUX3_2, the switching circuit SW3_1, the switching circuit SW3_2, the USB downstream port DFP3_1, and the video output port DFP3_2 shown in FIG. 9 may be referenced to the corresponding descriptions of the USB upstream port UFP3_1, the USB upstream port UFP3_2, the switching circuit SW3_4, the multiplexer MUX3_1, the switching circuit SW3_3, the multiplexer MUX3_2, the switching circuit SW3_1, the switching circuit SW3_2, the USB downstream port DFP3_1, and the video output port DFP3_2 as depicted in FIG. 3. Therefore, redundant explanations will not be provided herein.

In the operation mode depicted in FIG. 9, the USB-C connector U8_1 and the connector U8_2 are connected to the mobile device 91 (which may be, for example, a USB host, laptop, or mobile phone, but is not limited to these). The connector U8_2 may be either a DP connector or a USB-C connector. In the operation mode shown in FIG. 9, the switching circuit SW3_3 electrically connects the SBU pin of the USB upstream port UFP3_2 to the AUX_CH pin of the video output port DFP3_2. The switching circuit SW3_4 electrically connects the USB2 data pin pair of the USB upstream port UFP3_1 to the USB2 data pin pair of the USB downstream port DFP3_1. The multiplexer MUX3_1 and the switching circuit SW3_1 electrically connect the two high-speed data pin pairs of the USB upstream port UFP3_1 to the USB downstream port DFP3_1. Additionally, the multiplexer MUX3_2 and the switching circuit SW3_2 electrically connect the four high-speed data pin pairs of the USB upstream port UFP3_1 to the video output port DFP3_2. Consequently, the mobile device 91 may utilize the resources associated with the USB hub HUB8 and the video processing circuit 810.

The USB-C connector U8_1, the USB-C connector U8_2, the USB hub HUB8, and the video processing circuit 810 shown in FIG. 10 may be referenced to the corresponding descriptions of the USB-C connector U8_1, the USB-C connector U8_2, the USB hub HUB8, and the video processing circuit 810 as illustrated in FIG. 8. The USB upstream port UFP3_1, the USB upstream port UFP3_2, the switching circuit SW3_4, the multiplexer MUX3_1, the switching circuit SW3_3, the switching circuit SW3_1, the switching circuit SW3_2, the USB downstream port DFP3_1, and the video output port DFP3_2 depicted in FIG. 10 may be referenced to the corresponding descriptions of the USB upstream port UFP3_1, the USB upstream port UFP3_2, the switching circuit SW3_4, the multiplexer MUX3_1, the switching circuit SW3_3, the switching circuit SW3_1, the switching circuit SW3_2, the USB downstream port DFP3_1, and the video output port DFP3_2 as shown in FIG. 3. Therefore, further elaboration on these components will not be provided herein to avoid redundancy.

In the operation mode illustrated in FIG. 10, the USB-C connector U8_1 and the connector U8_2 are connected to the mobile device 91 (which may, for example, be a USB host), and the connector U8_2 may be a USB-C connector. In the operation mode shown in FIG. 10, the multiplexer MUX3_2 depicted in FIG. 3 may be disabled. The switching circuit SW3_3 electrically connects the SBU pin of the USB upstream port UFP3_1 to the AUX_CH pin of the video output port DFP3_2. The switching circuit SW3_4 electrically connects the USB2 data pin pair of the USB upstream port UFP3_1 to the USB2 data pin pair of the USB downstream port DFP3_1. The multiplexer MUX3_1 and the switching circuit SW3_1 electrically connect two high-speed data pin pairs of the USB upstream port UFP3_1 to the USB downstream port DFP3_1. Additionally, the multiplexer MUX3_1 and the switching circuit SW3_2 electrically connect another two high-speed data pin pairs of the USB upstream port UFP3_1 to the video output port DFP3_2. Consequently, the mobile device 91 may utilize the resources associated with the USB hub HUB8 and the video processing circuit 810.

Based on the foregoing, the USB routing integrated circuit 300 has multiple upstream ports (e.g., USB upstream ports UFP3_1 and UFP3_2) and multiple downstream ports (e.g., USB downstream port DFP3_1, video output port DFP3_2). The multiplexer MUX3_1, the multiplexer MUX3_2, the switching circuits SW3_1 and the switching circuit SW3_2 are capable of flexibly providing diverse transmission paths from various upstream ports to different downstream ports, contingent upon the actual application/operation mode of the USB routing integrated circuit 300.

Although the present disclosure has been disclosed by way of embodiments as described above, it is not intended to limit the scope of the disclosure. Any person of ordinary skill in the relevant art may make modifications and refinements without departing from the spirit and scope of this disclosure. Therefore, the scope to be protected by the present disclosure shall be defined by the appended claims.

What is claimed is:

1. A USB routing integrated circuit, comprising:
a first USB upstream port;
a second USB upstream port;
a USB downstream port;
a video output port;
a first multiplexer, coupled to the first USB upstream port;
a second multiplexer, coupled to the second USB upstream port;
a first switching circuit, coupled between the first multiplexer and the USB downstream port, and coupled between the second multiplexer and the USB downstream port, wherein the first switching circuit selectively electrically connects one of the first multiplexer and the second multiplexer to the USB downstream port in different operation modes; and
a second switching circuit, coupled between the first multiplexer and the video output port, and coupled between the second multiplexer and the video output port, wherein the second switching circuit selectively electrically connects one of the first multiplexer and the second multiplexer to the video output port in different operation modes, the first multiplexer selectively electrically connects the first USB upstream port to one of the first switching circuit and the second switching circuit in different operation modes, and the second multiplexer selectively electrically connects the second USB upstream port to one of the first switching circuit and the second switching circuit in different operation modes.

2. The USB routing integrated circuit according to claim 1, further comprising:
a third switching circuit, coupled to a sideband use pin of the first USB upstream port, coupled to a sideband use pin of the second USB upstream port, and coupled to an auxiliary channel pin of the video output port, wherein the third switching circuit selectively electrically connects one of the sideband use pin of the first USB upstream port and the sideband use pin of the second USB upstream port to the auxiliary channel pin of the video output port in different operation modes.

3. The USB routing integrated circuit according to claim 2, further comprising:
a fourth switching circuit, coupled to a USB2 data pin pair of the first USB upstream port, coupled to a USB2 data pin pair of the second USB upstream port, and coupled to a USB2 data pin pair of the USB downstream port, wherein the fourth switching circuit selectively electrically connects one of the USB2 data pin pair of the first USB upstream port and the USB2 data pin pair of the second USB upstream port to the USB2 data pin pair of the USB downstream port in different operation modes.

4. The USB routing integrated circuit according to claim 3, further comprising:
an intelligent function circuit; and
a human interface device monitor circuit, coupled to the intelligent function circuit, and coupled to a data transmission path between the fourth switching circuit and the USB2 data pin pair of the USB downstream port, wherein the human interface device monitor circuit monitors a human interface device data packet transmitted through the data transmission path to determine whether to notify the intelligent function circuit to execute an intelligent function.

5. The USB routing integrated circuit according to claim 4, wherein the intelligent function comprises:
controlling the third switching circuit to electrically connect the sideband use pin of the first USB upstream port to the auxiliary channel pin of the video output port; or
controlling the third switching circuit to electrically connect the sideband use pin of the second USB upstream port to the auxiliary channel pin of the video output port.

6. The USB routing integrated circuit according to claim 4, wherein the intelligent function comprises:
controlling the fourth switching circuit to electrically connect the USB2 data pin pair of the first USB upstream port to the USB2 data pin pair of the USB downstream port; or
controlling the fourth switching circuit to electrically connect the USB2 data pin pair of the second USB upstream port to the USB2 data pin pair of the USB downstream port.

7. The USB routing integrated circuit according to claim 6, wherein the intelligent function circuit is further coupled to the fourth switching circuit, and the intelligent function further comprises:
controlling the fourth switching circuit to electrically connect the intelligent function circuit to the USB2 data pin pair of the USB downstream port.

8. The USB routing integrated circuit according to claim 1, wherein the USB routing integrated circuit is implemented in a monitor device, the first USB upstream port is electrically connected to a first USB-C connector of the monitor device, the second USB upstream port is electrically connected to a second USB-C connector of the monitor device, the USB downstream port is electrically connected to a USB hub of the monitor device, the video output port is electrically connected to a video processing circuit of the monitor device, and the video processing circuit generates video data for a display module of the monitor device.

9. The USB routing integrated circuit according to claim 1, wherein the USB routing integrated circuit is implemented in a dock, the first USB upstream port is electrically connected to a first USB-C connector of the dock, the second USB upstream port is electrically connected to a second USB-C connector of the dock or a first displayport (DP) connector, the USB downstream port is electrically connected to a USB hub of the dock, the video output port is electrically connected to a multi-stream transport (MST) circuit of the dock, and the MST circuit generates video data for at least one second DP connector of the dock.

10. An operation method of a USB routing integrated circuit, wherein the USB routing integrated circuit comprises a first USB upstream port, a second USB upstream port, a USB downstream port, a video output port, a first multiplexer, a second multiplexer, a first switching circuit, and a second switching circuit, wherein the first multiplexer is coupled to the first USB upstream port, the second multiplexer is coupled to the second USB upstream port, the first switching circuit is coupled between the first multiplexer and the USB downstream port, the first switching circuit is coupled between the second multiplexer and the USB downstream port, the second switching circuit is coupled between the first multiplexer and the video output port, and the second switching circuit is coupled between the second multiplexer and the video output port, the operation method comprising:
selectively electrically connecting, by the first switching circuit, one of the first multiplexer and the second multiplexer to the USB downstream port in different operation modes;
selectively electrically connecting, by the second switching circuit, one of the first multiplexer and the second multiplexer to the video output port in different operation modes;
selectively electrically connecting, by the first multiplexer, the first USB upstream port to one of the first switching circuit and the second switching circuit in different operation modes; and
selectively electrically connecting, by the second multiplexer, the second USB upstream port to one of the first switching circuit and the second switching circuit in different operation modes.

11. The operation method according to claim 10, wherein a third switching circuit of the USB routing integrated circuit is coupled to a sideband use pin of the first USB upstream port, the third switching circuit is coupled to a sideband use pin of the second USB upstream port, and the third switching circuit is coupled to an auxiliary channel pin of the video output port, and the operation method further comprising:
selectively electrically connecting, by the third switching circuit, one of the sideband use pin of the first USB upstream port and the sideband use pin of the second USB upstream port to the auxiliary channel pin of the video output port in different operation modes.

12. The operation method according to claim 11, wherein a fourth switching circuit of the USB routing integrated circuit is coupled to a USB2 data pin pair of the first USB upstream port, the fourth switching circuit is coupled to a USB2 data pin pair of the second USB upstream port, and the fourth switching circuit is coupled to a USB2 data pin pair of the USB downstream port, and the operation method further comprising:
selectively electrically connecting, by the fourth switching circuit, one of the USB2 data pin pair of the first USB upstream port and the USB2 data pin pair of the second USB upstream port to the USB2 data pin pair of the USB downstream port in different operation modes.

13. The operation method according to claim 12, wherein the USB routing integrated circuit further comprises an intelligent function circuit and a human interface device monitor circuit, the human interface device monitor circuit is coupled to the intelligent function circuit, the human interface device monitor circuit is coupled to a data transmission path between the fourth switching circuit and the USB2 data pin pair of the USB downstream port, the operation method further comprising:
monitoring, by the human interface device monitor circuit, a human interface device data packet transmitted through the data transmission path to determine whether to notify the intelligent function circuit to execute an intelligent function.

14. The operation method according to claim 13, wherein the intelligent function comprises:
controlling the third switching circuit to electrically connect the sideband use pin of the first USB upstream port to the auxiliary channel pin of the video output port; or
controlling the third switching circuit to electrically connect the sideband use pin of the second USB upstream port to the auxiliary channel pin of the video output port.

15. The operation method according to claim 13, wherein the intelligent function comprises:
controlling the fourth switching circuit to electrically connect the USB2 data pin pair of the first USB upstream port to the USB2 data pin pair of the USB downstream port; or
controlling the fourth switching circuit to electrically connect the USB2 data pin pair of the second USB upstream port to the USB2 data pin pair of the USB downstream port.

16. The operation method according to claim 15, wherein the intelligent function circuit is further coupled to the fourth switching circuit, and the intelligent function further comprises:
controlling the fourth switching circuit to electrically connect the intelligent function circuit to the USB2 data pin pair of the USB downstream port.

17. The operation method according to claim 10, wherein the USB routing integrated circuit is implemented in a monitor device, the first USB upstream port is electrically connected to a first USB-C connector of the monitor device, the second USB upstream port is electrically connected to a second USB-C connector of the monitor device, the USB downstream port is electrically connected to a USB hub of the monitor device, the video output port is electrically connected to a video processing circuit of the monitor device, and the video processing circuit generates video data for a display module of the monitor device.

18. The operation method according to claim 10, wherein the USB routing integrated circuit is implemented in a dock, the first USB upstream port is electrically connected to a first USB-C connector of the dock, the second USB upstream port is electrically connected to a second USB-C connector of the dock or a first displayport (DP) connector, the USB downstream port is electrically connected to a USB hub of the dock, the video output port is electrically connected to a multi-stream transport (MST) circuit of the dock, and the MST circuit generates video data for at least one second DP connector of the dock.
